(19) United States
(12) Patent Application Publication
(10) Pub. No.: US 2020/0069102 A1
(43) Pub. Date: Mar. 5, 2020

(54) SYSTEM FOR PREPARING FOOD BY MICROWAVES

(71) Applicant: ELECTROLUX APPLIANCES AKTIEBOLAG, Stockholm (SE)

(72) Inventors: David Joao MACHADO MARTINS, Rothenberg ob der Tauber (DE); Trevor SPECHT, Rothenberg ob der Tauber (DE); Ricardo MORGADO, Rothenberg ob der Tauber (DE)

(21) Appl. No.: 16/468,175

(22) PCT Filed: Nov. 30, 2017
(86) PCT No.: PCT/EP2017/081079

§ 371 Date: Jun. 10, 2019

(30) Foreign Application Priority Data
Dec. 21, 2016 (EP) 16205844.0

(51) Int. Cl. A47J 27/00; H05B 6/64; H05B 6/66; H05B 6/76; H05B 6/78; H05B 6/80; A47J 43/046

(52) U.S. Cl. CPC A47J 27/004; H05B 6/6408; H05B 6/666; A47J 43/046; H05B 6/782; H05B 6/80; H05B 6/76

(57) ABSTRACT

The present invention relates to a system for preparing food by microwaves, comprising a microwave generator, in particular a magnetron, at least one food container formed of a microwave-tight material, at least one lid adapted for closing an open top side (40) of said at least one food container and for sealing it in a microwave-tight way, a stirrer rotatably arranged inside said food container and adapted to be driven by a motor, preferably by a motor arranged outside of the food container, a docking station adapted to removably receive said at least one food container in a configuration in which the food container is sealed by said at least one lid and to feed microwaves generated by said microwave generator into the food container for heating any food comprised therein, preferably wherein the docking station includes a motor for driving said stirrer inside the food container.

The present invention relates to a system for preparing food by microwaves.

In a microwave oven the food is radiated with microwave from one side and heated up. In order to obtain a uniform heat distribution, the food is rotated on a rotary disc or the microwaves are distributed by a rotating stirrer inside the oven cavity. The microwave oven of the prior art comprises a treatment chamber wherein the food can be placed for heating by the microwaves and a door for closing the treatment chamber. The treatment chamber in the closed state of the door is safely sealed against the escape of microwaves into the surrounding kitchen where they could cause hazards to the user. The treatment chamber is con-nected via a waveguide to a microwave generator, often a mag-netron, that is arranged outside of the treatment chamber in-side the microwave oven housing to efficiently and safely re-ceive microwaves for heating the food. However, the conven-tional microwave oven with the treatment chamber sealed by the door has the important draw back that it has a fixed volume that cannot be flexibly adapted to the treatment of food of variable size amount. The customer has to decide for once on the desired volume of the treatment chamber when buying the conventional microwave oven. Later during use, it often turns out either too small or too bulky.

It is an object of the present invention to provide a system for preparing food by microwaves, which allows the food preparation with an effective heat distribution that has been designed to enable its flexible adaptation to different amounts of food.

The object is achieved by the system for preparing food according to claim 1.

According to the present invention a system for preparing food by microwaves, wherein the system comprises:
a microwave generator, e.g. a magnetron or any other type of radio frequency or high frequency generator that is capable to generate high frequency radiation that is suitable for heating food,
at least one food container formed of a microwave-tight material,
a lid adapted for closing an open top side of said at least one food container and for sealing it in a microwave-tight way,
a stirrer rotatably arranged inside said food container and adapted to be driven by a motor, preferably by a motor arranged outside of the food container,
a docking station adapted to removably receive said at least one food container in a configuration in which the food container is sealed by said at least one lid and to feed microwaves generated by said microwave generator into the food container for heating any food comprised therein,
preferably wherein the docking station includes a motor for driving said stirrer inside the food container.

Preferably, the stirrer is adapted for mixing, cutting and/or mincing the food in the food container. The food container can include a first driving shaft connected to the stirrer and extending along the rotation axis of the stirrer, the docking station can include a second driving shaft connected to and rotatable by the motor, wherein the second driving shaft is connectable or connected to the first driving shaft of the food container.

The present invention aims at providing a docking station that is adapted to take up a removable and microwave-tight food container and to safely feed microwaves generated by said microwave generator into said microwave-tight food container, wherein said food container comprises a motor-driven rotatable stirrer in order to effectively and evenly heat any food comprised inside said microwave-tight food container. A particularly important part of the system of the invention is the rotatable stirrer that is arranged inside the microwave-tight food container and that can be driven by an external motor. The stirrer effectively avoids any uneven heating of the food inside the food container that might otherwise be caused by its heating by microwaves. The stirrer mixes, cuts and/or minces the food in the food container. The stirrer allows an efficient cooking of the food. A particular advantage of the invention is that it allows to use several food containers each comprising a stirrer that can be removably coupled to the docking station and therefore to the microwave generator, thereby allowing to prepare food in several food containers. In preferred embodiments the docking station is adapted to take up removable microwave-tight food containers of at least two different volumes, thus allowing to adapt the system of the invention for preparing food by microwaves to the treatment of different amounts of food. The system can comprise a single docking station and can thus be adapted to take up only a single food container t at a given time in order to feed microwaves into it. In alternative, the system can comprise at least two docking stations allowing thus to take up a corresponding number of food container at the same time. The system can comprise more than one microwave generator, e.g. it can comprise two microwave generators and two corresponding docking stations for food containers. In that case, the microwave generators can be controlled independently of each other, allowing independent cooking of food. A docking station can be adapted to take up a food container of at least one predetermined size. A docking station can be adapted to take up food containers of at least two predetermined different sizes. The microwaves heats up the food in the food container, while at the same time, the food is mixed, cut and/or minced by said stirrer.

In a first preferred embodiment, the rotatable stirrer arranged inside the food container is connected to a rotatable axis that penetrates the food container, preferably the bottom of the food container, and that can be removably coupled to a motor of the system. Preferably, the rotatable axis is sealed by a suitable sealing in a corresponding through hole of the food container, preferably in the bottom thereof, against the escape of water, liquid food, preferably also against the escape of microwaves. The axis is adapted to be removably coupled via a corresponding detachable coupling means to the driving motor. Preferably the motor is part of the docking station. Still preferably the motor and the detachable coupling means for the stirrer axis are comprised in a part of the docking station that is adapted to support the bottom of the food container. The arrangement of the motor in the docking station allows that the food container requires no motor and is cleanable in a dishwasher.

In an alternative second embodiment, the rotatable stirrer comprises a magnetic material and is adapted to be driven without direct mechanical contact by a motor-driven rotating magnetic device that is arranged below in the docking station the bottom of food container. In that embodiment the food container comprises at least a corresponding section of its bottom that is adapted to allow the magnetic interaction between the magnetic stirrer arranged above it inside the food container and the motor-driven rotating magnetic device that is arranged below it.

The microwave generator of the system is preferably arranged in order to feed microwaves into the food container from the top side thereof. In a first embodiment, the docking station can comprise a releasable coupling device adapted to establish a microwave-tight coupling of the microwave generator to a corresponding through hole in the lid of the food container in order to efficiently and safely feed microwaves for the heating of food into the food container. The microwave generator can be coupled to the lid of the food container by coupling a microwave antenna, in particular a wave guide communicating with the microwave antenna of the microwave generator, to said through hole in the lid. In that embodiment, in a first step the user can close the food container with the lid in a microwave tight way, e.g. with a suitable sealing device between the food container and the lid, and in a second step the user can couple the food container with the closed and sealed lid to the docking station and hence also to the microwave generator in a microwave tight way, e.g. with a suitable sealing device between the lid and the coupling device of the docking station for the lid.

In an alternative embodiment of the invention, the microwave generator is integrated into the lid for the food container, wherein the lid forms part of the docking station. In that case there is no need for any releasable coupling device for microwave-tight coupling of the microwave generator to a through hole of the lid as described above. Thereby an increased level of user safety is reached in that one microwave tight coupling can be avoided. The user only needs to close the open top side of the food container to the lid of the food container that forms part of the docking station of the system of the invention, at the same lime establishing a microwave-tight sealing of the food container to the lid.

In preferred variants of said second embodiment the system of the invention comprises at least two food containers comprising different volumes adapted to take up different amounts of food, however wherein said food containers comprise an open top that is in each case adapted to be coupled and sealed to the same lid that forms part of the docking station.

Preferably, the food container includes a bottom, side walls and an open top side. In particular, the rotation axis of the driving shaft extends vertically.

For example, the second driving shaft is rotatable around the rotation axis and forms a torque proof unit with the first driving shaft, when the food container is received by the docking station.

Further, the bottom and the side walls of the food container may be made of metal. The bottom and the side wall made of metal prevent that the microwaves escape from the food container through said bottom and side wall.

Additionally, the system comprises at least one lid for closing the open top side of the food container and sealing it against the escape of microwaves to the ambience. Preferably, the lid is made of at least one material adapted to prevent the leakage of microwave.

The lid may include at least one microwave generator, e.g. magnetron or any other type of radio frequency or high frequency generator that is capable to generate high frequency radiation that is suitable for heating food, for radiating microwaves through the open top side into the food container and/or the lid may include at least one coupling arrangement adapted for a microwave-coupling to at least one microwave generator, e.g. magnetron.

Moreover, the system may comprise at least one control device for controlling the microwave generator, e.g. magnetron, and/or the system may comprise at least one safety device. Preferably, said safety device is adapted to avoid generation of microwaves unless the lid has been microwave-tightly closed, if the microwave generator, e.g. magnetron, is part of the lid, and unless the vessel is microwave-tightly coupled to the microwave generator, if the microwave generator is not part of the lid. For example, the safety device includes one or more micro-switches recognising the coupling between the lid and the vessel or between the microwave generator and the microwave-coupling, respectively.

In particular, the stirrer may include at least one sharp edge for cutting and/or mincing the food in the food container. The one or more sharp edges contribute for the multiple use of the stirrer.

Preferably, a lower part of the first driving shaft and an upper part of the second driving shaft are formed complementary to each other, so that the first driving shaft and the second driving shaft are connectable or connected to each other and form the torque proof unit.

For example, the first driving shaft includes a gear wheel at its lower portion, wherein the second driving shaft of the docking station is at least partially complementary to said gear wheel, so that the first driving shaft and the second driving shaft connected to each other are torque proof.

Further, at least one docking station may be a freestanding and mobile device.

Alternatively or additionally, the system comprises a drawer moveable in and out of a kitchen furniture cabinet, wherein at least one docking station is an integrated part of said drawer.

In alternative, the system may comprise at least one drawer adapted for installation in a piece of kitchen furniture, e.g. a kitchen cabinet, wherein said drawer includes at least one docking station, and wherein said drawer and hence said docking station are moveable between a position inside the piece of kitchen furniture and the position in front of said piece of kitchen furniture.

Moreover, the system comprises at least one scale system, wherein said scale system is integrated within the food container and/or within the docking station.

Novel and inventive features of the present invention are set forth in the appended claims.

The present invention will be described in further detail with reference to the drawings, in which

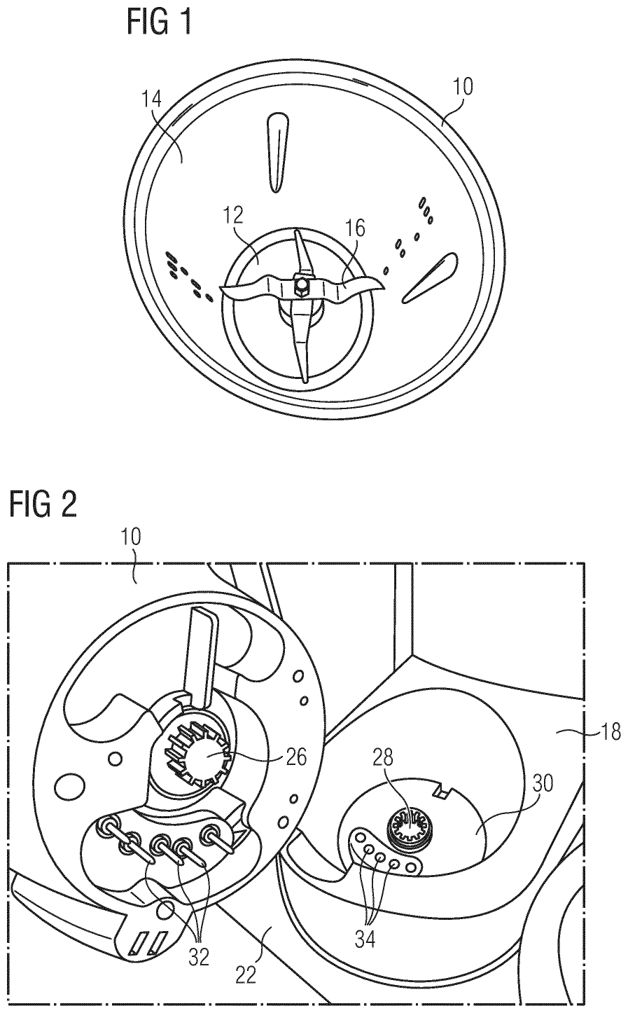

FIG. 1 illustrates a schematic perspective view of a food container for preparing food according to a first embodiment of the present invention,

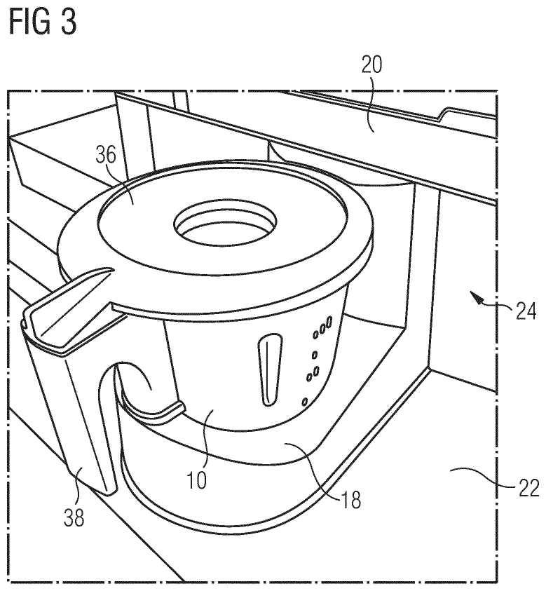

FIG. 2 illustrates a schematic perspective view at the lower side of the food container and at a docking station for said food container according to the first embodiment of the present invention,

FIG. 3 illustrates a schematic perspective view of the food container received by the docking station according to the first embodiment of the present invention, and

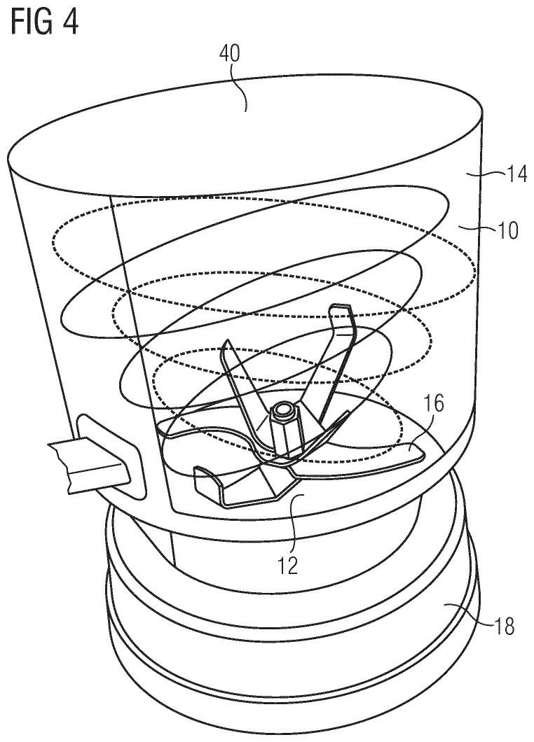

FIG. 4 illustrates a schematic perspective view of the food container for preparing food according to a second embodiment of the present invention.

FIG. 1 illustrates a schematic perspective view of a food container 10 for preparing food according to a first embodiment of the present invention. The food container 10 is provided for preparing food by microwaves.

The food container 10 includes a circular bottom 12 and a cylindrical side wall 14. Further, the food container 10 includes a stirrer 16 arranged above the bottom 12 of said food container 10. The stirrer 16 is rotatable around a vertical rotation axis. Said vertical rotation axis extends perpendicular to the bottom 12. In this embodiment, the vertical axis extends through the centre of the bottom 12. For example, the stirrer 16 is made of metal. In this example, the bottom 12 and the side wall 14 of the food container 10 are made of metal. The bottom 12 and the side wall 14 made of metal prevent that the microwaves escape from the food container 10 through said bottom 12 and side wall 14.

The stirrer 16 mixes, cuts and/or minces the food in the food container 10. Thus, the stirrer 16 allows an efficient cooking of the food. The microwaves heats up the food in the food container 10. At the same time, the food is mixed, cut and/or minced by the stirrer 16. The food container 10 with the stirrer 16 allows a uniform heating of the food.

FIG. 2 illustrates a schematic perspective view at the lower side of the food container 10 and at a docking station 18 for said food container 10 according to the first embodiment of the present invention. The food container 10 and the docking station 18 form a system for preparing food by microwaves.

In this embodiment, the docking station 18 is arranged on a drawer 22. Said drawer 22 is provided for installation in a piece 20 of kitchen furniture 24, e.g. a kitchen cabinet, and includes the docking station 18. The drawer 22 and hence the docking station 18 are slidable between a position inside the piece 20 of kitchen furniture 24 and a position in front of said piece 20 of kitchen furniture 24.

Further, the food container 10 includes a first driving shaft 26. Said first driving shaft 26 is connected to the stirrer 16. The first driving shaft 26 extends along the rotation axis of the stirrer 16. In this example, a gear wheel is attached at the lower end of the first driving shaft 26. Said gear wheel is connectable to a second driving shaft 28 arranged in a recess 30 of the docking station 18. The second driving shaft 28 is rotatable and directly or indirectly driven by a motor. For example, said motor is arranged inside the docking station 18. Optionally, electric contact elements 32 are arranged at the lower side of the food container 10, wherein said electric contact elements 32 are connectable to further electric contact elements 34 arranged in the recess 30 of the docking station 18. The food container 10 is cleanable in a dishwasher.

Alternatively, the motor may be arranged inside the food container 10 and beneath the bottom 12 of said food container 10. In this case, the motor is controlled and supplied with power via the electric contact elements 32 and 34.

FIG. 3 illustrates a schematic perspective view of the food container 10 received by the docking station 18 according to the first embodiment of the present invention.

The docking station 18 is arranged on the drawer 22 of the piece 20 of kitchen furniture 24. The drawer 22 is slidable between the position inside the piece 20 of kitchen furniture 24 and the place in front of said piece 20 of kitchen furniture 24. The food container 10 is received by the docking station 18. Further, the food container 10 is closed by a lid 36. Said lid 36 is removable from the food container 10. Moreover, the food container 10 comprises a handle 38 arranged at the side wall 14. The drawer 22 is moveable into the piece 20 of kitchen furniture 24 together with the docking station 18 and the food container 10.

For example, the lid 36 includes at least one microwave generator, which is not shown, for radiating microwaves through the open top side 40 into the food container 10. Preferably, the microwave generator is a magnetron. Alternatively, the lid includes at least one coupling arrangement adapted for a microwave-coupling to at least one microwave generator. Moreover, the microwave generator may be arranged inside the piece 20 of kitchen furniture 24, wherein preferably a wave guide may be provided for feeding the microwaves into the food container 10 via the lid 36.

Further, the system may comprise at least one control device for controlling the microwave generator. Moreover, the system may comprise at least one safety device. Preferably, said safety device is adapted to avoid generation of microwaves unless the lid 36 has been microwave-tightly closed, if the microwave generator is part of the lid 36, and unless the vessel is microwave-tightly coupled to the microwave generator, if the microwave generator is not part of the lid 36.

The microwave generator can be arranged inside the docking station 18 (not shown) near the lid 36 of the food container 10. The through hole of the lid 36 shown in FIG. 3 can be releasably coupled via a—not shown—microwave tight coupling device to the docking station and hence to the microwave generator. In that case, the lid 36 may be a separate part and microwave-tightly connectable to the food container 10 as well as to the docking station 18. Alternatively, the lid 36 may be an integral part of the docking station 18, wherein said lid 36 is microwave-tightly connectable to the food container 10 (not shown).

FIG. 4 illustrates a schematic perspective view of the food container 10 for preparing food according to a second embodiment of the present invention.

The food container 10 includes the circular bottom 12, the cylindrical side wall 14 and the stirrer 16. Said stirrer 16 is arranged above the bottom 12. The stirrer 16 is rotatable around the vertical rotation axis. Said vertical rotation axis extends perpendicular to the bottom 12. In this example, the vertical axis extends through the centre of the bottom 12. For example, the stirrer 16 is made of metal. In this example, the bottom 12 and the side wall 14 of the food container 10 are also made of metal. The bottom 12 and the side wall 14 made of metal prevent that the microwaves escape from the food container 10 through said bottom 12 and side wall 14.

The stirrer 16 cuts, mixes and/or minces the food in the food container 10. Thus, the stirrer 16 allows an efficient cooking of the food. The microwaves heats up the food in the food container 10, while the food is mixed, cut and/or minced by said stirrer 16 at the same time. The food container 10 with the stirrer 16 allows the uniform heating up of the food.

The food container 10 is arranged above the docking station 18. In the second embodiment, the docking station 18 is a freestanding device. The food container 10 and the docking station 18 form the system for preparing food by microwaves. In contrast, the docking station 18 of the first embodiment is integrated in the drawer 22 of the piece 20 of kitchen furniture 24. The motor for driving the stirrer 16 may be arranged either beneath the bottom 12 inside the food container 10 or in the docking station 18. In the first case, the docking station 18 provides the motor inside the food container 10 with power. In the second case, the food container 10 may include the first driving shaft 26 connected to the stirrer 16 and connectable to the second driving shaft 28 in the docking station 18. Moreover, in the second case, the food container 10 is cleanable in the dishwasher.

The food container 10 includes an open top side 40. The microwaves enter the food container 10 through said open top side 40. For example, the open top side 40 of the food container 10 is covered by a lid with an integrated microwave generator. Preferably, said microwave generator is a magnetron. Alternatively, the food container 10 is covered by a lid including a coupling arrangement adapted for a microwave-coupling to a microwave generator, e.g. magnetron. Thus, the food container 10, the docking station 18, the lid and the integrated microwave generator are used as a freestanding device.

Additionally, the food prepared in the food container 10 may be heated up by induction heating, radiant heating and/or thick-film heating technologies beside the microwave heating.

The first and second embodiments of the present invention may be combined. For example, the system for preparing food by microwaves may comprise the food container 10, the docking station 18 integrated within the drawer 22 according to the first embodiment and the freestanding docking station 18 according to the second embodiment.

The food container 10 and/or the docking station 18 may communicate with other cooking appliances. Further, the food container 10 and/or the docking station 18 may communicate with a mobile and/or stationary computer device.

A scale system may be integrated in the food container 18 and/or docking station 18, in particular in the bottom 12 of the food container 10. Said scale system may communicate with other cooking appliances and/or with the mobile and/or stationary computer device.

The system according to the present invention is an independent microwave device. The food container 10 is microwave-tight. The food container 10 and the docking station 18 are freestanding in the kitchen. Alternatively, the docking station 18 is an integrated part of the drawer 22, wherein the docking station 18 receives the food container 10.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 food container
12 bottom
14 side wall
16 stirrer
18 docking station
20 piece of kitchen furniture
22 drawer
24 kitchen furniture
26 first driving shaft
28 second driving shaft
30 recess
32 electric contact elements of the food container
34 electric contact elements of the docking station
36 lid
38 handle
40 open top side

1. A system for preparing food by microwaves, comprising:
a microwave generator,
a food container formed of a microwave-tight material,
a lid adapted for closing an open top side of said food container and for sealing it in a microwave-tight way,
a stirrer rotatably arranged inside said food container and adapted to be driven by a motor,
a docking station adapted to removably receive said food container in a configuration in which the food container is sealed by said lid and to feed microwaves generated by said microwave generator into the food container for heating any food therein.

2. The system according to claim 1, wherein the food container includes a bottom, side walls and an open top side, the bottom and the side walls of the food container being made of metal.

3. The system according to claim 1, wherein the docking station is adapted to feed microwaves generated by said microwave generator into the food container via said lid.

4. The system according to claim 1, wherein lid is made of material adapted to prevent leakage of microwaves.

5. The system according to claim 1, wherein the lid is irremovably connected to the docking station or wherein the lid comprises a through hole for feeding microwaves into the food container, wherein said through hole is adapted to be removably connected to the docking station and hence to the microwave generator via a microwave-tight sealing.

6. The system according to claim 1, further comprising a control device for controlling the microwave generator, and/or a safety device adapted to avoid generation of microwaves unless the lid has been microwave-tightly closed if the microwave generator is part of the lid, and unless the vessel is microwave-tightly coupled to the microwave generator if the microwave generator is not part of the lid.

7. The system according to claim 1, comprising a control device for controlling the motor that drives the stirrer arranged inside the food container.

8. The system of claim 1, wherein the docking station comprises a section that is adapted to support a bottom of the removable food container and that comprises the motor for the stirrer.

9. The system according to claim 1, wherein the stirrer is adapted for mixing, cutting and/or mincing the food in the food container, the stirrer comprising at least one sharp edge for cutting and/or mincing the food in the food containers.

10. The system according to claim 1, wherein a lower part of a first driving shaft connected to the stirrer and an upper part of a second driving shaft connected to the motor are formed complementary to each other, so that the first driving shaft and the second driving shaft are connectable or connected to each other and form a torque proof unit.

11. The system according to claim 1, wherein the food container includes a first driving shaft connected to the stirrer and extending along a rotation axis, the docking station includes a second driving shaft connected to and rotatable by the motor, and the second driving shaft is connectable or connected to the first driving shaft of the food container, wherein the rotation axis of the driving shaft extends vertically, wherein the second driving shaft is rotatable around the rotation axis and forms a torque proof unit with the first driving shaft when the food container is received by the docking station, wherein the first driving shaft includes a gear wheel at its lower portion, wherein the second driving shaft of the docking station is at least partially complementary to said gear wheel so that the first driving shaft and the second driving shaft connected to each other are torque proof.

12. The system of claim 1, comprising at least two said food containers each being removable and with different volumes for taking up food, each comprising an open top side being adapted to be coupled to said lid that has at least one of the same size and shape.

13. The system according to claim 1, further comprising a drawer moveable inside and out of a cavity of a kitchen furniture cabinet, wherein said docking station is an integrated part of said drawer.

14. The system according to claim 1, further comprising a scale system integrated within the food container and/or within the docking station.

15. The system according to according to claim 1, further comprising a drawer adapted for installation in a piece of kitchen furniture, wherein said drawer includes said docking station, and wherein said drawer and hence said docking station are moveable between a position inside the piece of kitchen furniture and a position in front of said piece of kitchen furniture.

16. The system according to claim 1, said docking station comprising a motor adapted to drive from outside the food container said stirrer located inside the food container.

17. A system for preparing food by microwaves, comprising:
first and second open-topped food containers each formed of a microwave-tight material and each having a stirrer disposed therein at a bottom thereof and being connected to a respective first driving shaft that extends through the bottom of the respective container;
a docking station adapted to removably receive and seat the bottom of each said container, the docking station comprising a microwave generator for generating microwaves and a motor operatively coupled to a second driving shaft, a lower part of said first driving shaft of each said container and an upper part of said second driving shaft being formed complementarily to one another such that when the respective container is seated in said docking station its first driving shaft and said second driving shaft form a torque proof unit;
a first lid formed of a microwave-tight material adapted for closing an open top side of the first food container and for sealing it in a microwave-tight way, the first lid being adapted to couple to said microwave generator when the first container is seated in said docking station, with said first lid closing said first container, in order to introduce microwaves generated by said microwave generator into said first container via a through hole in said lid; and
a safety device that avoids generation of microwaves unless said lid is microwave-tightly coupled to said microwave generator, said safety device comprising a microswitch that recognizes the coupling between the lid and the microwave generator.

18. The system according to claim 17, said first lid being further adapted for closing an open top side of the second food container and for sealing it in a microwave-tight way, the first lid being adapted to couple to said microwave generator when the second container is seated in said docking station, with said first lid closing said second container, in order to introduce microwaves generated by said microwave generator into said second container via said through hole.

19. The system according to claim 17, said first and second containers having different volumes.

20. The system according to claim 17, said docking station being disposed in a drawer of a kitchen furniture.
